(19) United States
(12) Patent Application Publication
(10) Pub. No.: US 2019/0084886 A1
(43) Pub. Date: Mar. 21, 2019

(54) MGO-PARTIALLY STABILIZED ZIRCONIA SOLID ELECTROLYTE DOPED WITH MN OR CO

(71) Applicant: PUSAN NATIONAL UNIVERSITY INDUSTRY-UNIVERSITY COOPERRATION FOUNDATION, Busan (KR)

(72) Inventors: Hee Soo LEE, Busan (KR); Seol JEON, Gimhae-si (KR); Ji Seung RYU, Busan (KR); Bu Young KIM, Gimhae-si (KR); Seung Hyeon JO, Busan (KR); Hyun Jo YOO, Busan (KR)

(73) Assignee: PUSAN NATIONAL UNIVERSITY INDUSTRY-UNIVERSITY COOPERRATION FOUNDATION, Busan (KR)

(21) Appl. No.: 16/084,733

(22) PCT Filed: Mar. 14, 2017
(86) PCT No.: PCT/KR2017/002719

§ 371 Date: Sep. 13, 2018

(30) Foreign Application Priority Data
Mar. 14, 2016 (KR) 10-2016-0030331

(51) Int. Cl. C04B 35/48; C04B 35/01; C04B 35/64; C04B 35/626; C04B 35/638; C04B 35/634; G01N 27/411; G01N 27/04

(52) U.S. Cl. CPC C04B 35/48; C04B 35/016; C04B 35/64; C04B 35/6261; C04B 35/6264; C04B 2235/9676; C04B 35/63416; G01N 27/4112; G01N 27/041; C04B 2235/3246; C04B 2235/3265; C04B 35/638

(57) ABSTRACT

The present disclosure relates to solid electrolyte containing MgO partially stabilized zirconia doped with at least one of Mn and Co.

### TECHNICAL FIELD

The present disclosure relates to a solid electrolyte including MgO partially stabilized zirconia doped with at least one of Mn and Co.

### BACKGROUND

Oxygen to be injected into molten iron to oxidize and refine impurities such as C, Si, and P in steelmaking process gradually increases as the refining progresses. Dissolved oxygen forms an inclusion such as bubble and oxide, which greatly deteriorates a quality of steel (or copper metal). Deoxidation is performed by adding a deoxidizing agent or an alloy element to remove the dissolved oxygen. A control of the oxygen concentration of the molten metal is important in a quality management of steel products.

The deoxidation in the steelmaking process should be able to quickly and directly measure the oxygen concentration in the molten steel in a converter, a ladle, or a tundish whenever desired. A measurement method using a sensor (metallurgical oxygen sensor) for measuring the dissolved oxygen in the molten steel is widely used for measuring the dissolved oxygen in the molten steel because the method may quickly and accurately measure and analyze oxygen activity in-situ.

As a solid electrolyte material for the sensor for measuring the dissolved oxygen in the molten steel, a MgO partially stabilized zirconia solid electrolyte that exhibit excellent thermal shock resistance may be used in molten steel at 1600° C. or higher is widely used.

However, this stabilized zirconia-based solid electrolyte has the following problem. A ZrO₂-based solid electrolyte in a cubic phase at a temperature of 2370° C. or higher, a tetragonal phase at 1170° C. to 2370° C., and a monoclinic phase at 1170° C. or lower.

In order to be adapted as a solid electrolyte material, attempts have been made to substitute ions having a low electrovalence such as Y³⁺, Ca²⁺, Mg²⁺, etc. at the Zr⁴⁺ position to form oxygen vacancies, but when used as the solid electrolyte meterial for the metallurgical oxygen sensor considering an operation process at 1500° C. or higher, ion conductivity and phase stability are degraded by a lattice strain caused by the thermal shock.

### SUMMARY

In one aspect, the present disclosure relates to a solid electrolyte comprising MgO partially stabilized zirconia doped with at least one of Mn and Co.

Herein, any one of Mn and Co doping is substituted into a zirconium position to form an oxygen vacancy. The MgO partially stabilized zirconia doped with the Mn or the Co has an improved ionic conduction compared to MgO partially stabilized zirconia not doped with the Mn or the Co because of the formation of the oxygen vacancy.

The MgO partially stabilized zirconia doped with the Mn or the Co is present only in a cubic phase at room temperature, and maintains the cubic phase at a room temperature and a temperature of 1500° C. or higher, thereby to exhibit excellent stability.

In another aspect, the present disclosure provides a sensor for measuring dissolved oxygen in molten steel at 1500° C. or higher, wherein the sensor includes the solid electrolyte.

The solid electrolyte of the present disclosure provides a cubic phase stability and a high ion conductivity at high temperatures, and thus may be used as the solid electrolyte in a high temperature environment.

In another aspect, the present disclosure provides a method for producing Mn and Co-doped partially stabilized zirconia, the method comprising: mixing MgO partially stabilized zirconia powders and manganese oxide or cobalt oxide powders to form a mixture; and sintering the mixture.

A ratio of the MgO partially stabilized zirconia powders and the manganese oxide or cobalt oxide powders may be in a range of from 1:5 to 1:10.

The mixing of the powders includes ball-milling the MgO partially stabilized zirconia powder and the manganese oxide or the cobalt oxide powder in solvent. The solvent may preferably be alcohol solvent.

The method for the producing Mn or Co-doped partially stabilized zirconia includes, before the sintering, mixing the powders with a binder to form a mixture, press-forming the mixture, and then, removing the binder at a high temperature. The binder may preferably be polyvinyl alcohol.

### BRIEF DESCRIPTION OF THE DRAWINGS

FIG. 1 shows crystal structure changes in examples of the present disclosure.

FIG. 2 shows ionic conductivities in examples of the present disclosure.

### DETAILED DESCRIPTION

Hereinafter, embodiments of the present disclosure will be described in detail with reference to the accompanying drawings. The present disclosure is susceptible of various modifications and alternative constructions, certain preferred embodiments have been shown in the drawings and will be described below in detail, it should be understood, however, that there is no intention to limit the disclosure to the specific forms disclosed but, on the contrary, the disclosure is to cover all modifications, alternative constructions and equivalents falling within the spirit and scope of the disclosure as expressed in the appended claims. Like reference numerals are used for similar elements in describing each drawing.

It is to be understood that the terminology used herein is used for the purpose of describing particular embodiments only, and is not intended to limit the scope of the present disclosure. It must be noted that as used herein and in the appended claims, the singular forms “a,” “an,” and “the” include the plural reference unless the context clearly dictates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Example 1: Preparation of MgO Partially Stabilized Zirconia Powder

In order to synthesize 8 mol % MgPSZ powder, mixed solution of ZrCl₂ and MgCl₂.2H₂O was prepared. The mixed solution was added into an ultrasonic stirrer, stirred at 250 rpm, and ammonia solution was added until the pH of the solution reached 10 to precipitate a co-precipitate. Thereafter, the mixture was stirred at a speed of 300 rpm for 2 to 3 hours. Hereinafter, the co-precipitate was filtered while washing the stirred mixed solution with ethanol and distilled water. The filtered precipitate was dried at 100° C. for 12 hours, and subsequently calcined at 600° C. for 2 hours.

### Example 2

The MgO partially stabilized zirconia powder produced in Example 1 was prepared. This MgO partially stabilized zirconia powder was mixed with Mn₂O₃ powder in a molar ratio of 1:1, and, then, the mixture was subjected to a ball milling using zirconia ball in ethanol as the solvent at 300 rpm for 24 hours. The ball milled mixed powder was mixed with a PVA (polyvinyl alcohol) binder at a ratio of 10:1 wt %. Thereafter, the mixture was placed in a mold (disc type: 20 Ø, 2 g·bar type: 60 mm×70 mm, 3 g) and uni-axially press-formed (20 Mpa, 1 m 30 s). The subsequently obtained molded body was raised in temperature at a heating speed of 5° C./min and held at 500° C. for 1 hour to remove the binder, and sintered at 1600° C. for 6 hours.

### Example 3

The procedure of Example 2 was repeated, except that the molar ratio of the MgO partially stabilized zirconia powder and Mn₂O₃ powder in Example 2 was 1:5.

### Example 4

The procedure of Example 2 was repeated, except that the molar ratio of the MgO partially stabilized zirconia powder and Mn₂O₃ powder in Example 2 was 1:10.

### Example 5

The procedure of Example 2 was repeated, except that the molar ratio of the MgO partially stabilized zirconia powder and Mn₂O₃ powder in Example 2 was 1:15.

### Characteristic Evaluation

A Pt wire electrode was wound on the solid electrolyte for ion conductivity measurement prepared in Examples 1 to 5 at intervals of 1 cm, and Pt paste was applied to the place where the electrode was wound. The resultant was fired at 900° C. for 1 hour, and its ion conductivity was measured via a DC 4-terminal method. A phase stability was evaluated as follows.

### Evaluation of the Ionic Conductivity and Stability of the Cubic Phase

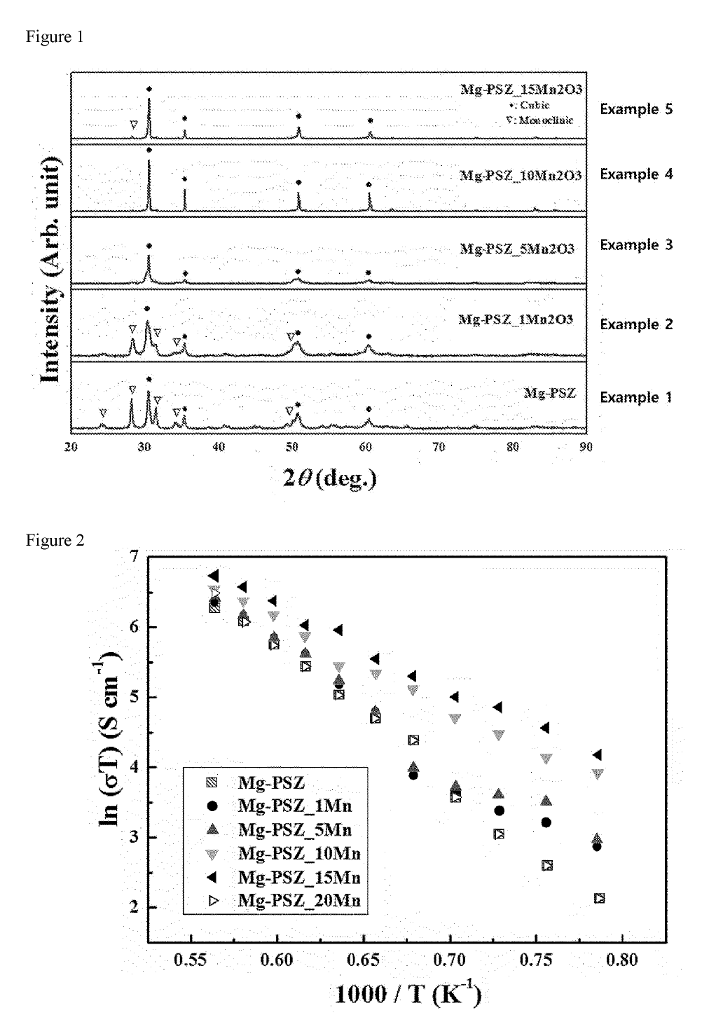

When the zirconia-based solid electrolyte is present in a monoclinic phase at room temperature, a phase transition thereof to a tetragonal phase occurs at and from 1200° C. and then a phase transition thereof to a cubic phase occurs at and from 2370° C. Therefore, there is a problem that the phase transition occurs when it is used in a sensor for measuring oxygen in molten steel at 1500° C. or higher. As shown in FIG. 1, in the case of Example 1 in which Mn is not doped, a peak of a monoclinic phase is observed in addition to the cubic phase at room temperature as in the conventional problems, thus the phase transition to the monoclinic may be observed. However, in the case of Examples 2 to 5 corresponding to the present disclosure doped with Mn, it was confirmed that only a cubic phase peak which may hardly be observed in the monoclinic phase was observed. This proves the phase stability based on a temperature between high and low temperatures in the case of the present disclosure.

In addition, as shown in FIG. 2, the Mn-doped Mg—PSZ solid electrolyte (0.732 S·cm⁻¹) showed about 1.5 times higher ion conductivity than the solid electrolyte (0.392 S·cm⁻¹) without doping with Mn. This is considered to be due to an increase in a charge carrier concentration depending on the formation of oxygen vacancies by addition of manganese and cobalt.

1. A solid electrolyte containing MgO partially stabilized zirconia doped with at least one of Mn and Co.

2. The solid electrolyte according to claim 1, wherein in the MgO partially stabilized zirconia doped with the Mn or the Co, at least one of the Mn and the Co is substituted into a zirconium position to form an oxygen vacancy.

3. The solid electrolyte according to claim 1, wherein the MgO partially stabilized zirconia doped with the Mn or the Co is present only in a cubic phase at room temperature.

4. The solid electrolyte according to claim 1, wherein the MgO partially stabilized zirconia doped with the Mn or the Co has an improved ionic conduction compared to MgO partially stabilized zirconia not doped with Mn or Co.

5. A sensor for measuring dissolved oxygen in molten steel, wherein the sensor includes the solid electrolyte according to claim 1.

6. An ion conductivity measuring sensor for measuring an ion conductivity at a temperature of 1500° C. or higher, wherein the sensor includes the solid electrolyte according to claim 1.

7. A method for producing Mn or Co-doped partially stabilized zirconia, the method comprising:
mixing MgO partially stabilized zirconia powders and manganese oxide powders or cobalt oxide powders to form a mixture; and
sintering the mixture.

8. The method for producing the Mn or Co-doped partially stabilized zirconia according to claim 7, wherein a ratio of the MgO partially stabilized zirconia powders and the manganese oxide powders or the cobalt oxide powders is in a range of from 1:5 to 1:10.

9. The method for producing the Mn or Co-doped partially stabilized zirconia according to claim 7, wherein the mixing of the powders includes ball-milling the MgO partially stabilized zirconia powders and the manganese oxide powders or the cobalt oxide powders in solvent.

10. The method for producing the Mn or Co-doped partially stabilized zirconia according to claim 9, wherein the solvent is alcohol solvent.

11. The method for producing the Mn or Co-doped partially stabilized zirconia according to claim 9, wherein the method includes, before the sintering, mixing the powders with a binder to form a mixture, press-forming the mixture, and then, removing the binder at a high temperature.

12. The method for producing the Mn or Co-doped partially stabilized zirconia according to claim 11, wherein the binder is polyvinyl alcohol.
